(19) United States
(12) Patent Application Publication
(10) Pub. No.: US 2009/0212134 A1
(43) Pub. Date: Aug. 27, 2009

(54) FUEL INJECTOR

(75) Inventors: Ian Walter Drake, Colchester Essex (GB); Neil Vernon Avis, Essex (GB)

Correspondence Address: BANNER & WITCOFF, LTD., 28 STATE STREET, 28th FLOOR, BOSTON, MA, 02109-9601, US

(73) Assignee: MAN B & W DIESEL, LTD., Chesire (GB)

(21) Appl. No.: 11/912,778

(22) PCT Filed: Apr. 28, 2006
(86) PCT No.: PCT/GB2006/001574

§ 371 Date: Jun. 11, 2008

(30) Foreign Application Priority Data
Apr. 28, 2005 (GB) 0508665.7

(51) Int. Cl. F02M 61/00; F02M 61/14; F02M 69/46

(52) U.S. Cl. 239/533.3; 123/470; 123/456

(57) ABSTRACT

A common-rail fuel injector (1) has a forged housing containing a nozzle and a reservoir (2) for supplying the nozzle with fuel. In order to reduce its height the housing integrally incorporates a flow limiter (4) and a filter (5) in a laterally protruding portion (1a) to which the fuel pipe is connected at (18). This means that the reservoir can be held in place underneath the engine cover (30) by a clamp (3) between the rocker levers (16) in a space-saving manner, and the injector can be removed without disturbing the valves.

The present invention is concerned with fuel injectors for common-rail diesel engines.

In common-rail injection systems the fuel is compressed by a single pump and fed to the respective cylinder heads. See, for instance, JP 8-261105 (Mitsubishi). Generally operation takes place at very high pressures, and in use significant pressure fluctuations through the system can arise. It is generally desirable to dampen these as far as possible, and one way of doing this is to incorporate a large volume on the supply side. Although in principle one could do this by using large pipes between the pump and the cylinders, this is undesirable, not least for safety reasons, and generally one uses a reservoir adjacent to each injector nozzle. Incorporating a reservoir makes the individual injectors quite bulky. Moreover additional components, in particular filters and flow limiters, also need to be used with each injector. However, these further increase the height of the injector housing and in some cases make it impossible to house all the parts under the cylinder head cover.

WO 03/076794 (Hlousek/Robert Bosch GmbH) shows a fuel injector in FIG. 3 that has an integral accumulator 36. A flow limiter 35 is located immediately below the accumulator, and to the side of the flow limiter are the electrical contacts for the actuator. The structure is very tall, and it is not shown how it would be physically accommodated on the cylinder block. The structure of FIG. 5 has a lateral accumulator and it is still less clear how this would fit in an engine layout.

According to an aspect of the invention there is provided a fuel injector having a housing containing a nozzle and a reservoir for supplying the nozzle with fuel, in which the housing integrally incorporates a flow limiter and optionally also a filter; the flow limiter is accommodated to the side of the accumulator, in a protruding part or wing of the housing that when the injector is installed fits between two of the engine valves in a four-valve cylinder head. This projecting part also contains the fuel pipe terminal, to the side of the reservoir.

Integration of the flow limiter and/or filter in the same housing as the reservoir is not simple because of the great pressure prevailing in the reservoir, implying that the walls of the reservoir must be uninterrupted. In embodiments of the invention, the reservoir is a substantially vertical cylinder and the flow limiter and edge filter are in line at an acute angle to the vertical next to the reservoir. The end of the filter can be connected to the inlet of the reservoir by a bore; this bore does not reduce the integrity of the housing because it is close to a narrow part, i.e. the lower end, of the reservoir.

Because the arrangement is of small vertical height, and because of the disposition of the flow limiter, it is possible to clamp the injector in place in such a way that it can be removed without disturbing the rocker gears for the valves. This means that the injector can be changed without the engine crankshaft or camshaft needing to be turned over. The clamp can be in the form of a lever mounted between the pair of rocker gears or levers that are present on a four-valve head; the lever is preferably on the opposite side of the injector to the wing housing the limiter.

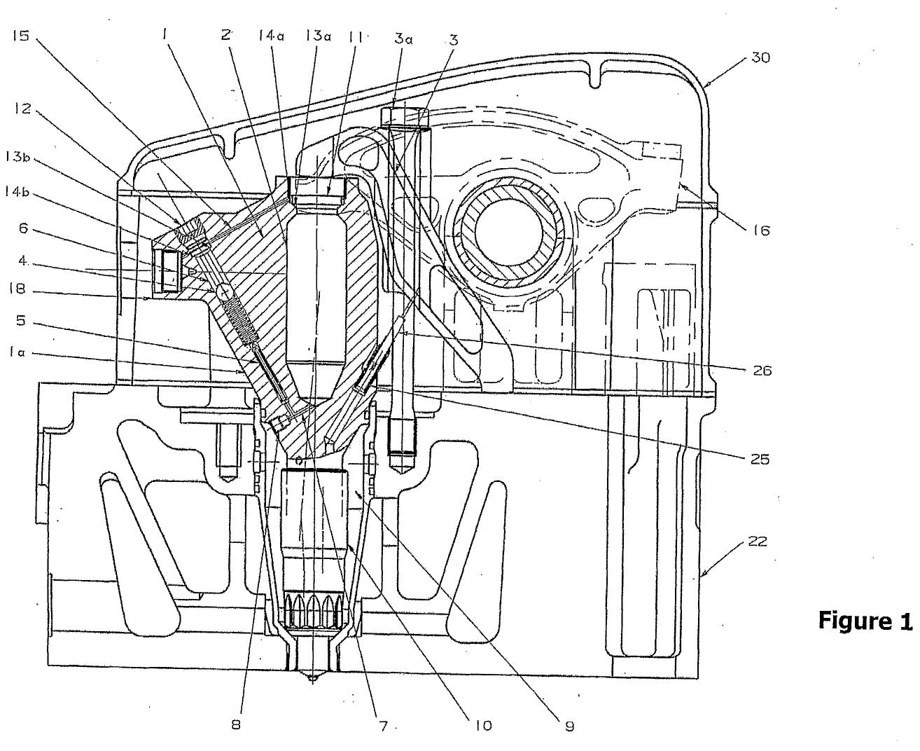

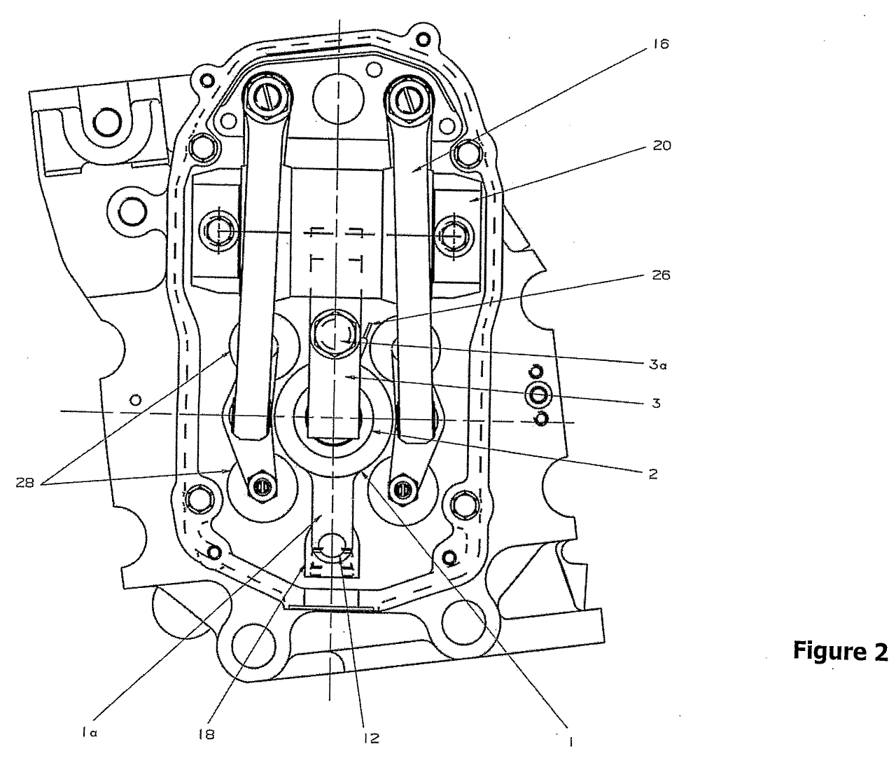

For a better understanding of the invention, embodiments of it will now be described by with reference to the accompanying drawings, in which FIG. 1 shows a section in elevation of a fuel injector in accordance with the invention; and FIG. 2 shows the same injector in plan view.

As shown in FIG. 1, the, body or housing of the injector 1, which is manufactured from a steel forging and has walls about 15 mm thick, contains a generally cylindrical or bullet-shaped reservoir or accumulator 2. The housing is generally cylindrical, but has a wing 1a to one side. The accumulator 2 is centrally located, and has a diameter large enough to allow the top of the accumulator to be relatively low, which in turn means that the injector height allows room for an injector clamp 3 to bear on to the top of the injector, while still housed under a cover 30. The volume for a large diesel engine might be 77 cm With a fuel delivery volume of the order of 1 cm³, say up to 1.2 cm³, the ratio of the two is likely to be about 65.

The lower (nozzle-side) end of the reservoir cavity is tapered, so that the wall of the injector is less stressed at the bottom portion by the pressure of the fuel, Words such as “top” and “bottom” are used for convenience by reference to the direction of injection, taken to be vertical. Usually the elongate reservoir is also generally in line with this direction, i.e. also vertical, but this need not be the case.

The injector body 1 also contains a flow limiter 4 and an edge filter 5, housed in a cross-drilling 6 in the wing la, angled at about 30° to the vertical. This bore 6 feeds the accumulator at its lower, tapered, end via a connecting drilling 7 forming a T-junction with the cross-drilling 6. A plug 8 for the connecting drilling 7 is so arranged that, in the event of fuel leaking past the plug, the fuel vents into a cooling fuel jacket 9 which surrounds the nozzle nut 10 of the injector. The outlet of the reservoir is not shown, being slightly behind the inlet, near the tapered end also.

Similarly a metal plug 11 is located at the top of the accumulator 2, and a plug 12 is provided for the flow limiter and edge filter, these being so arranged that the plugs pull down onto corresponding conical seats 13a, 13b. In the event of fuel leakage past a seat, the fuel vents into respective small annular chambers 14a, 14b. These chambers are connected to each other via a further cross-drilling 15, and vent into the annular space provided within the double-skinned high-pressure fuel injection pipe, not shown, connected into the terminal 18 located in the wing 1a. Fuel leakage past either plug into the annular pipe space results in an alarm being triggered, as is known. By this means, fuel leakages are prevented from venting into the engine lubricating oil system, which could lead to a dangerous dilution.

It will be noted that the terminal or coupling port 18 is also located in the projecting wing 1a, adjacent to one end of the flow limiter. This further contributes to the compact design and low height. Further, there is only one such port per cylinder, rather than two as in WO 03/076794, which represents a simplification. Also, because the fuel entry is from the side, the pipe runs along the side of the cylinder head and does not obstruct removal of the cover 30.

The injector is held in place on the cylinder head 22 by a clamp bar 3 resting at one end of the cylinder head and at the other, cranked, end on the plug 11 of the accumulator. It is held down by a bolt 3a screwed into the cylinder head. There is enough space for the clamp to be located forward of the fulcrum 20 of the rocker arm, described below.

A second bore 25 is located in the injector body, on the opposite side to the flow limiter, i.e. on the clamp side. Again, it is adjacent to the lower, less stressed, part of the accumulator housing. This bore allows for the electrical wires 26 from the injector solenoid to be led away.

The overall arrangement allows the injector clamp 3 to be withdrawn without disturbing the inlet/exhaust rocker gear 16. It is thus possible to change an injector without the need to turn the engine crankshaft/camshaft over. As can be seen from FIG. 2, there are two rocker levers 16 per cylinder, one for each pair of valves 28, rotating about the fulcrum 20. The clamp fits between and in a plane parallel to the two levers.

The wing 1a of the injector housing fits between the forward pair of valves 28, extending past them sufficiently to allow connections of the fuel pipe to the terminal 18. Meanwhile the electrical connector 26 can be seen emerging slightly to the side of the central plane, emerging part-way up the housing of the accumulator.

The embodiment described has an integral flow limiter, and it is considered that this is the ideal construction. However, within the scope of the invention a separate flow limiter could be contemplated, or even an arrangement with no flow limiter at all, but the construction otherwise similar.

1. A fuel injector having a housing containing a nozzle and a reservoir for supplying the nozzle with fuel, characterized in that the housing integrally incorporates a flow limiter and optionally also a filter.

2. A fuel injector according to claim 1, in which the reservoir is a substantially vertical cylinder and the flow limiter and, if present, edge filter are in line at an acute angle to the vertical next to the reservoir.

3. A fuel injector according to claim 1, in which the housing of the injector is forged, with a thicker portion or wing on the side in which the flow limiter is located.

4. A fuel injector according to claim 1, in which the flow limiter and, if present, the filter connect to the reservoir by a transverse bore at the lower end of the reservoir.

5. A fuel injector according to claim 1, further including a bore for an electrical connector, in the housing on the side opposite the flow limiter.

6. A fuel injector having a housing containing a nozzle and a reservoir for supplying the nozzle with fuel, characterized in that the housing has a thicker portion or wing on one side of the reservoir, this thicker portion containing a a port for attachment of a fuel supply pipe.

7. (canceled)

8. An engine including a fuel injector according to claim 6 and a corresponding engine cylinder, the injector being held in place on the cylinder by a clamp.

9. An engine according to claim 8, in which the cylinder has four valves in pairs and the clamp is located between the pairs of valves.

10. An engine according to claim 8 and being of the common-rail injection type.

11. An engine including a fuel injector according to claim 1 and a corresponding engine cylinder, the injector being held in place on the cylinder by a clamp.

12. An engine according to claim 11, in which the cylinder has four valves in pairs and the clamp is located between the pairs of valves.

13. An engine according to claim 11 and being of the common-rail injection type.
